(19) United States
(12) Patent Application Publication
(10) Pub. No.: US 2013/0135212 A1
(43) Pub. Date: May 30, 2013

(54) HAPTIC KEYBOARD FOR A TOUCH-ENABLED DISPLAY

(71) Applicants: Sandie Ning Ning Cheng, Cypress, TX (US); Sana Syeda Ali, Spring, TX (US); Britt C. Ashcraft, Tomball, TX (US)

(72) Inventors: Sandie Ning Ning Cheng, Cypress, TX (US); Sana Syeda Ali, Spring, TX (US); Britt C. Ashcraft, Tomball, TX (US)

(21) Appl. No.: 13/811,456

(22) PCT Filed: Sep. 28, 2010
(86) PCT No.: PCT/US10/50483

§ 371 Date: Jan. 22, 2013

(51) Int. Cl. G06F 3/023

(52) U.S. Cl. CPC G06F 3/023
USPC 345/168

(57) ABSTRACT

Embodiments of the present invention disclose a haptic keyboard for a touch-enabled display of a portable electronic device. According to one example, the touch-enabled display unit is configured to display a keyboard having a plurality of interactive key selectors. A plurality of tractable members are coupled to the display unit, with each tractable member positioned to correspond with a boundary area of at least one key selector. Furthermore, each tractable member is configured to protrude from a front surface of the display unit so as to create a haptic border region for the corresponding key selector of the keyboard.

### BACKGROUND

The emergence and popularity of mobile computing has made portable electronic devices, due to their compact design and light weight, a staple in today's marketplace. In addition, many of these portable electronic devices include a touchscreen display device configured to detect the location and presence of a user's desired touch input. For example, a user's finger or a passive object, such as a stylus, may come into physical contact with the touchscreen display so as to register as an input at said location. Furthermore, some portable electronic devices include an on-screen virtual keyboard for enabling and facilitating character input on the touchscreen display by the user. Since typing and text entry are commonplace on traditional keyboards, efficient replication of these natural actions is essential for the success of portable electronic devices having touchscreen functionality.

### BRIEF DESCRIPTION OF THE DRAWINGS

The features and advantages of the inventions as well as additional features and advantages thereof will be more clearly understood hereinafter as a result of a detailed description of particular embodiments of the invention when taken in conjunction with the following drawings in which:

FIGS. 1A-1C are three-dimensional perspective views of a portable electronic device according to an example of the present invention.

FIG. 2 is an illustration of a portable electronic device and virtual keyboard according to an example of the present invention.

FIG. 3 is a simplified block diagram of the portable electronic device and associated components according to an example of the present invention.

FIGS. 4A-4C are side views of the portable electronic device and haptic feedback mechanism according to an example of the present invention.

FIG. 5 is a flow chart of the processing steps for implementing the haptic keyboard of the portable electronic device according to an example of the present invention.

### DETAILED DESCRIPTION OF THE INVENTION

The following discussion is directed to various embodiments. Although one or more of these embodiments may be discussed in detail, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Generally, when an on-screen keyboard is activated by components of the portable electronic device, the keyboard is simply displayed as a graphical element on the display unit. More particularly, individual key caps or characters of the keyboard are shown as elements forming a key legend. Due to the size of the virtual keyboard and key legend, in addition to the flat surface of the touchscreen display, many users find it difficult and cumbersome for efficient typing or text entry. Unlike a physical keyboard, there are no tactile-defined areas for these generic virtual keyboards. That is, the keys of standard virtual keyboards are only two-dimensional such that the user may visualize the keyboard, but cannot actually feel or depress individual keys.

Examples of the present invention provide a haptic on-screen keyboard for a portable electronic device. In particular, each key of the on-screen keyboard includes a tactile boundary area so as to create a haptic feedback mechanism for the user operating (i.e. typing) the touch-enabled display of the portable electronic device. With tactile boundaries configured for each individual key of the key legend, a haptic feedback area is created for the user to quickly identify the location of each key. As a result, a user may type with more precision and efficiency. Accordingly, examples of the present invention provide a haptic feedback mechanism for touch-enabled portable electronic devices, thus creating a more responsive and familiar typing environment for the user.

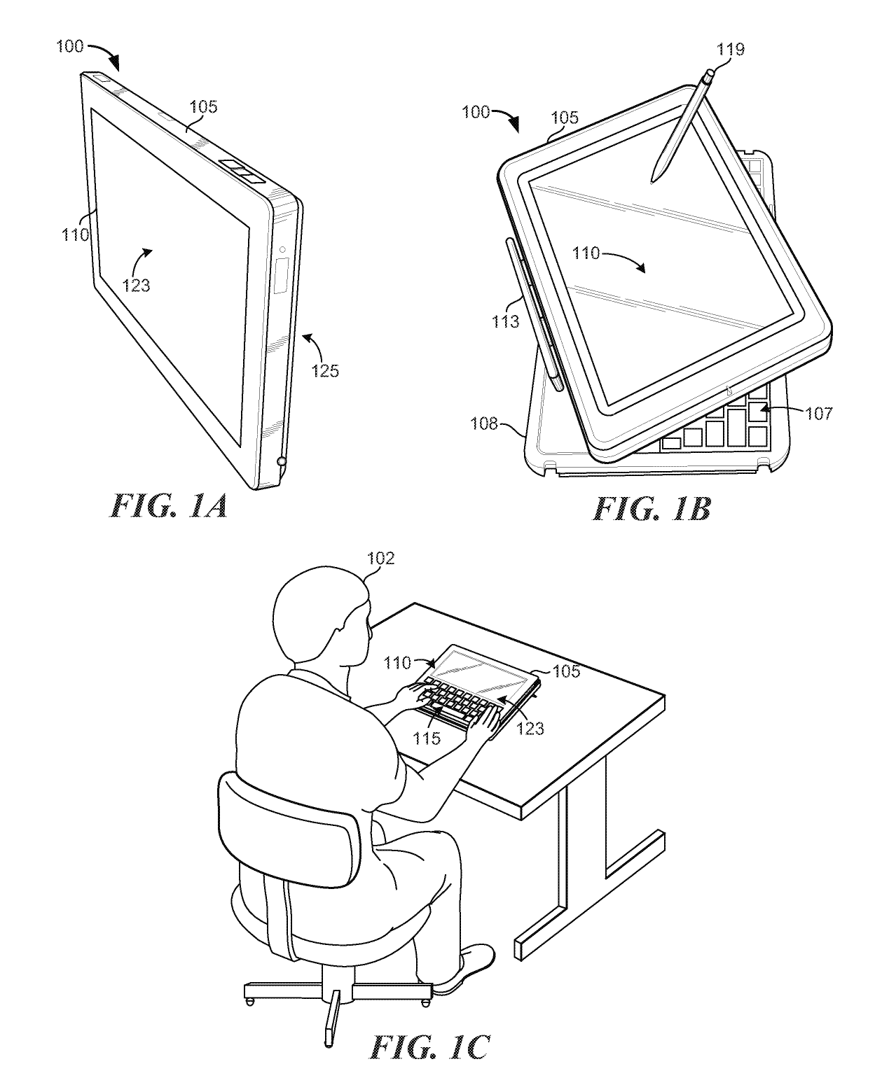

Referring now in more detail to the drawings in which like numerals identify corresponding parts throughout the views, FIGS. 1A-1C are three-dimensional perspective views of a portable electronic device according to an example of the present invention. As shown in FIG. 1A, the portable electronic device 100 includes an outer casing 105 for housing a display unit 110. In the present example, the portable electronic device is represented as a tablet personal computer and includes a front surface side 123 opposite a back surface side 125. FIG. 1B depicts a convertible laptop computer as the portable electronic device in accordance with an example of the present invention. In particular, the portable electronic device 100 of FIG. 1B includes a base housing 108 having an input means such as a physical keyboard 107, and a display housing 105 for encompassing a touch-enabled display unit 110. A stylus 119 may be used as an input device for the touch-enabled display unit 110. Furthermore, the display housing 105 is configured to rotate and fold downward from an upright position with respect to the base housing 108 via a hinge pivot assembly 113. FIG. 1C depicts the portable electronic device 100 in a normal operating environment according to one example. As shown here, the portable electronic device is presently operating in a keyboard mode in which the virtual on-screen keyboard 115 is activated on the touch-enabled display unit 110. While operating in the keyboard mode, the user 102 is able to type directly on the front surface side 123 of the display unit 110 via the virtual keyboard 115.

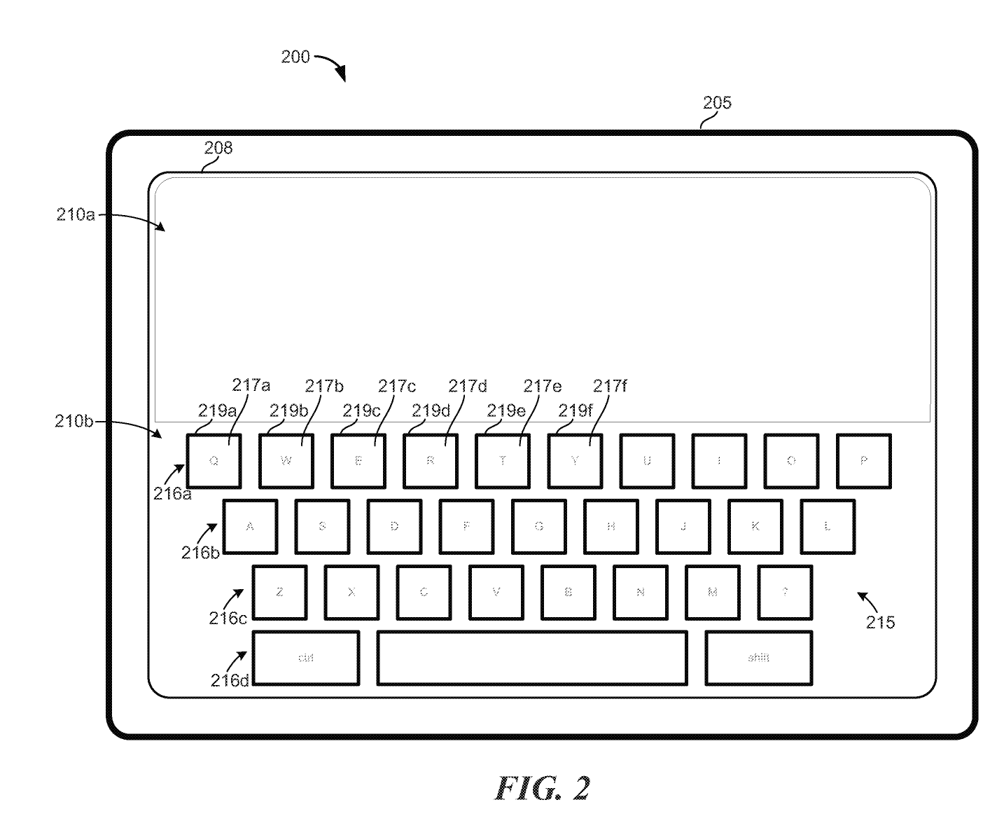

FIG. 2 is an illustration of a portable electronic device and virtual keyboard according to an example of the present invention. As shown here, the portable electronic device 200 includes an outer casing 205 for housing a touch-enabled video display unit 208 configured to display graphics and digital media. More particularly, display unit 208 is a flexible touchscreen display configured to detect the presence and location of a user's onscreen touch and may comprise of a resistive touchscreen panel, a capacitive touchscreen panel, an infrared touchscreen panel, or the like. The touchscreen display unit 208 is configured to display a graphical user interface for providing interactive graphics to a user, while also being configured to detect a user's physical touch. In addition, the touchscreen display unit may be configured to detect a hover event, in which an object such as a finger or stylus is not physically touching the display device, but is in close proximity. Furthermore, the display unit has a flexible front surface so as to allow tractable members to protrude thereform.

In the present example, the portable electronic device 200 is in a keyboard mode such that a top portion 210a of the graphical user interface displays an image or graphic, while a lower portion 210b displays a virtual keyboard 215 comprising of a plurality of individual keys or key selectors forming a key legend. As shown here, the virtual keyboard represents a standard QWERTY keyboard including rows of key selectors 216a-216d such as alphanumeric characters 217a-217f for example. The virtual keyboard 215 may also include numerical characters, punctuation characters, command characters, symbols, and the like. Furthermore, each key selector of the virtual keyboard includes a haptic border region 219a-219f created by a plurality of electrical members positioned on a back side of the display unit. The haptic border regions 219a-219f are created by the tractable members and represent an outline of each individual key selector 217a-217f so as to allow the user to easily identify each key selector of the virtual keyboard 215.

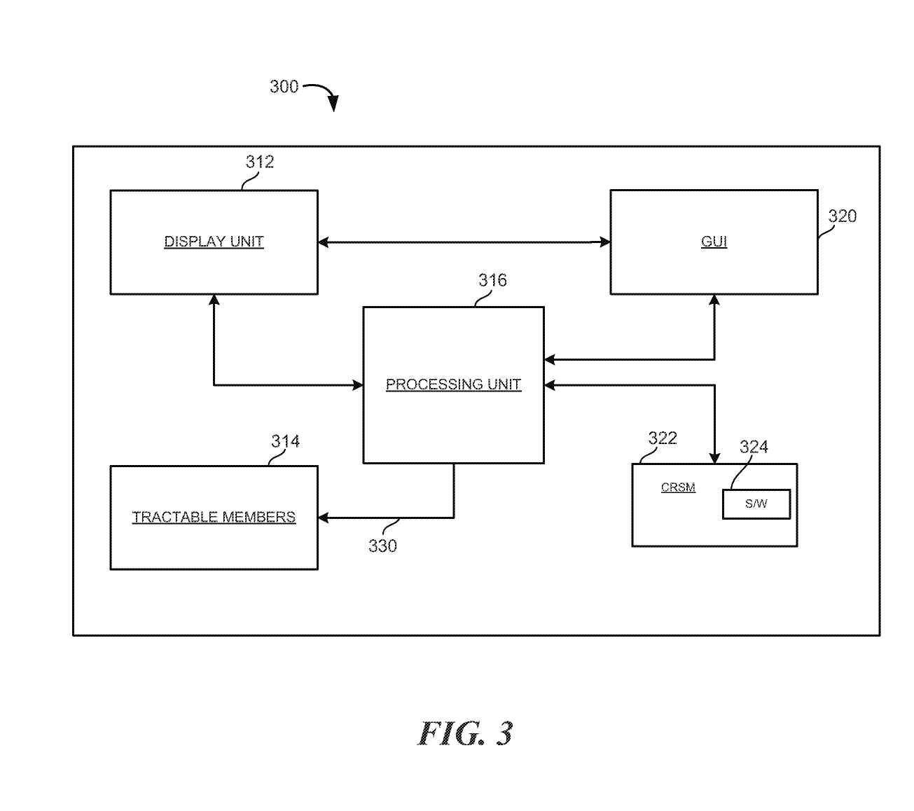

FIG. 3 is a simplified block diagram of the portable electronic device according to an example of the present invention. As shown in this example, the system 300 includes a processing unit 316 coupled to a display unit 312, a graphical user interface 320, tractable members 314, and a computer-readable storage medium 322. The processor 316 represents a central processing unit configured to execute program instructions. Display unit 312 represents an electronic visual display or touch-sensitive display configured to display images and the graphical user interface 320 for enabling interaction between the user and the computing system 300. Storage medium 322 represents volatile storage (e.g. random access memory), non-volatile store (e.g. hard disk drive, read-only memory, compact disc read only memory, flash storage, etc.), or combinations thereof. Furthermore, storage medium 324 includes software 324 that is executable by the processing unit 316 and, that when executed, causes the processing unit 316 to perform some or all of the functionality described herein.

According to one example of the present invention, tractable members 314 comprises of a conductive board of electoactive polymers configured to expand outward or rise perpendicularly with respect to the display unit upon receiving voltage from the processing unit via electrical connection 330. Tractable members 314 may be any material, actuator, sensor or the like configured to change in size and/or shape upon being stimulated by an electrical field, or mechanically. In one example, each tractable member is formed to correspond to a border region of each key selector of the virtual keyboard. Alternatively, the tractable members forming the haptic border regions may be formed for only a single key of the virtual keyboard, for two or more keys but not all, or for only a portion of the virtual keyboard.

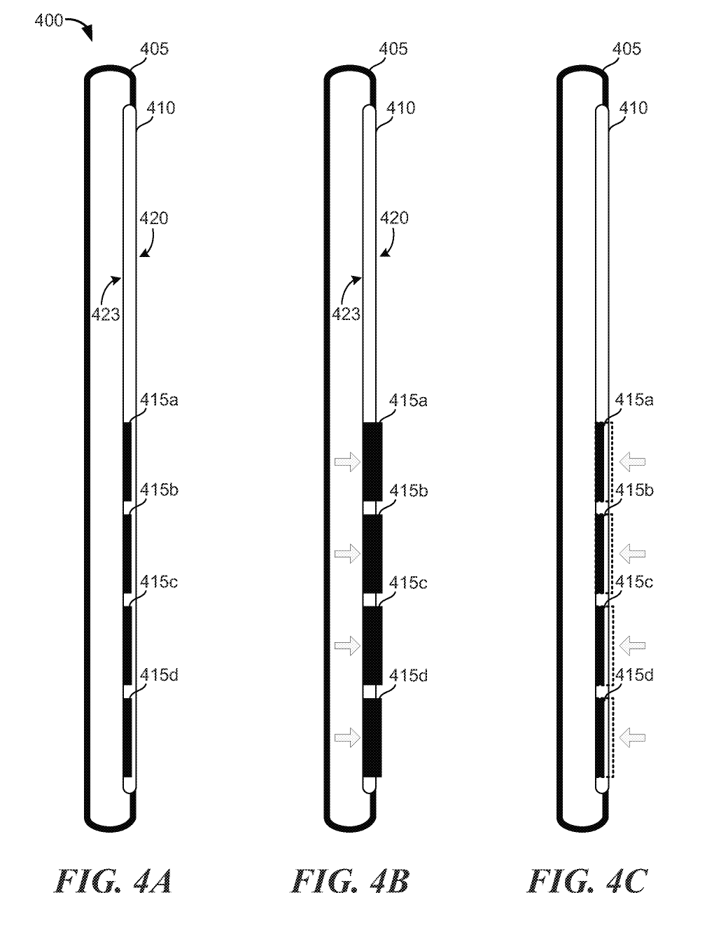

FIGS. 4A-4C are side views of the portable electronic device and haptic feedback mechanism according to an example of the present invention. According to one example, rows of tractable members 415a-415d, such as electroactive polymers, are attached to an underside 423 (opposite front surface side 420) of a display unit 410. When the processing unit indicates that the portable electronic device 400 is to operate in a keyboard mode, voltage is released to the plurality of tractable members 415-415d so as to cause the boundaries associated with each individual key selector of the key legend to protrude beyond the front surface 420 of the display unit 410 as shown in FIG. 4B. As mentioned earlier, the display unit has a flexible front surface so as to allow the tractable members to protrude and cause a slight elevation at the corresponding location. As such, a haptic border region is created around each key selector of the on-screen keyboard, thereby allowing the user to physically feel and visualize the virtual keyboard. When the portable electronic device is switched from the keyboard mode to a standard or display mode, the processing unit stops the supply of voltage to the plurality of electronic members 415a-415d so as to cause the boundaries of the key selectors to retract back into the portable electronic device and create a flush display surface 420 as shown in FIG. 4C.

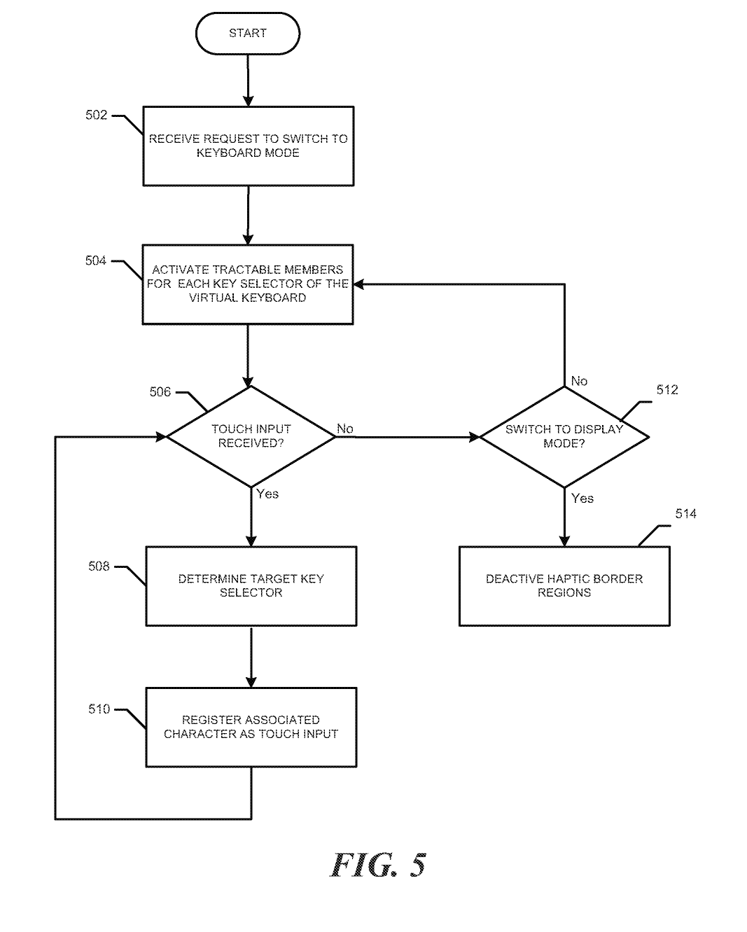

FIG. 5 is a flow chart of processing steps for implementing the haptic feedback mechanism of the portable electronic device according to an example of the present invention. In step 502, the processing unit receives a request for the graphical user interface to operate in a keyboard mode for displaying a virtual onscreen keyboard. This request may be made automatically when the portable electronic device is held at a certain orientation (e.g. landscape), or upon manual activation from a user via a physical button on the portable electronic device, a menu option on the graphical user interface, or the like. Thereafter, in step 504, the processor activates the haptic border regions of each key selector by supplying voltage to the tractable members coupled to the display unit. As a result, the supply of voltage causes the tractable members (e.g. electroactive polymers) to change in size and protrude outward in a perpendicular direction with respect to the flexible display unit. As a result, the user may feel the key border regions of the virtual keyboard where the tractable members have protruded the front surface of the flexible display.

In step 506, the processing unit determines if a touch input is received from the operating user. The touch input may be a user's finger or stylus physically touching an object of the graphical user interface, such as an individual key selector of the virtual keyboard. If a touch input is received on the virtual keyboard, then in step 508 the processing unit determines a target key selector based on the location of the touch input. Once the precise location of the touch input is determined, then in step 510, the processing unit registers the character associated with the key selector as the desired touch input. For example, if the user physically presses the character “R” on the virtual keyboard, then the processing unit registers and outputs the letter “R” on the graphical user interface associated with the display unit. On the other hand, if a touch input is not received, then in step 512 the processing unit determines if the graphical user interface should switch from the keyboard mode to a standard display mode. Again, this determination can be made automatically based on the orientation of the portable electronic device (e.g. switch from landscape to portrait), or upon manual activation from a user via a physical button, a menu option, or similar method. Upon switching to a display mode, the processing unit stops the supply of voltage to the tractable members (e.g. electroactive polymers) so as deactivate the haptic border regions of the virtual keyboard by causing the tractable members to revert back to an inactive state and the smaller, original size.

Examples of the present invention provide a haptic virtual keyboard for a touch-enabled display of a portable electronic device. According to one example, tractable members such as electroactive polymers are mounted on the backside of a display unit so that each corresponds with an outline (i.e. border region) of each letter or symbol of the virtual keyboard. Voltage from a processing unit coupled to the tractable members causes the border regions of the key selectors to activate when in a keyboard mode. In particular, the border around each key of the virtual keyboard will be raised in order to give the user a tactile feedback, i.e. the user can feel where the individual key starts and ends.

In addition, several advantages are afforded by the examples of the present invention. Haptic border regions allow the operating user to both see and rub the physical on-screen boundaries of the keyboard. As such, this configuration creates individual boundaries for the key legends and allows the user to locate and sense each key easily. This will facilitate more efficient text entry because it gives the user the effect of typing using physical buttons as on an external keyboard. Furthermore, by utilizing electroactive materials embedded within the device, these haptic borders can be raised accordingly, and when the virtual keyboard isn't in use the front surface of display immediately returns to a level or flush state.

Furthermore, while the invention has been described with respect to exemplary embodiments, one skilled in the art will recognize that numerous modifications are possible. For example, although exemplary embodiments depict a notebook computer and tablet computer as the portable electronic device, the invention is not limited thereto. For example, the portable electronic device may be a netbook, an all-in-one computer, a smartphone, or any other electronic device configured with a touch-enabled display.

Furthermore, the virtual keyboard and tractable members may be positioned at various locations with respect display unit as opposed to the lower half of the display as described and depicted herein. For example, the virtual keyboard and corresponding electrical border regions may be positioned on the upper half of the display or in a central area of the display. Thus, although the invention has been described with respect to exemplary embodiments, it will be appreciated that the invention is intended to cover all modifications and equivalents within the scope of the following claims.

What is claimed is:

1. A portable electronic device comprising:
a display unit having a touch-enabled surface and configured to display an on-screen keyboard, wherein the on-screen keyboard includes a plurality of interactive key selectors; and
a plurality of tractable members coupled to the display unit, wherein each tractable member is positioned to correspond with a boundary area for at least one key selector of the on-screen keyboard,
wherein each tractable member is configured to protrude from a front surface of the display unit so as to create a haptic border region for the corresponding key selector of the on-screen keyboard.

2. The portable electronic device of claim 1, further comprising:
a processor coupled to the display unit, wherein the processor is configured to switch the display unit from a display mode to a keyboard mode for receiving typographical input from a user via the onscreen keyboard.

3. The portable electronic device of claim 2, further comprising:
a graphical user interface coupled to the processing unit and configured to provide touch-activated objects on the front surface of the display unit.

4. The portable electronic device of claim 3, wherein when in the display mode, the graphical user interface is configured to display a first viewable image on the display unit.

5. The portable electronic device of claim 4, wherein when in the keyboard mode, a first portion of the graphical user interface is allocated to displaying the first viewable image, and a second portion of the graphical user interface is allocated to displaying the on-screen keyboard.

6. The portable electronic device of claim 2, wherein the plurality of tractable members comprises a conductive board of electroactive polymers mounted on an underside of the display unit.

7. The portable electronic device of claim 6, wherein when the portable electronic device is in the keyboard mode, each electroactive polymer receives voltage from the processor so as activate and protrude from the front surface of the display unit.

8. The portable electronic device of claim 1, wherein the on-screen keyboard is a QWERTY-formatted keyboard.

9. A method for interacting with a portable electronic device including a touch-enabled display unit and processor, the method comprising:
receiving a request to operate in a keyboard mode, wherein the keyboard mode includes a plurality of interactive key selectors associated with a character, and
activating at least one tractable member of a plurality of tractable members, wherein each tractable member corresponds with a boundary of each key selector of the virtual keyboard and is configured to protrude from display unit so as to create a haptic border region for the corresponding key selector.

10. The method of claim 9, further comprising:
receiving a touch input from a user via a virtual keyboard;
determining a target key selector based on received touch input.

11. The method of claim 10, further comprising:
registering the touch input as the character associated with the target key selector.

12. The method of claim 9, further comprising:
switching from a keyboard mode to a display mode; and
deactivating the plurality of tractable members when in a display mode.

13. The method of claim 9, wherein switching from a display mode to a keyboard mode comprises:
splitting a viewable area of the display unit into a first portion and second portion, wherein the first portion of the viewable area includes a first viewable image and the second portion of the viewable area includes the virtual keyboard.

14. A computer readable storage medium having stored executable instructions, that when executed by a processor, causes the processor to:
display an on-screen keyboard for receiving typographical touch input from a user, wherein the on-screen keyboard includes a plurality of key selectors;
activate at least one tractable member of a plurality of tractable members, wherein each tractable member corresponds with a boundary of each key selector of the on-screen keyboard and is configured to protrude from display unit so as to create a haptic border region for the corresponding key selector.

15. The computer readable storage medium of claim 14, wherein the executable instructions further cause the processor to:
receive a touch input from a user via a virtual keyboard;
determine a target key selector based on received touch input.
